(19) United States
(12) Patent Application Publication
(10) Pub. No.: US 2009/0233103 A1
(43) Pub. Date: Sep. 17, 2009

(54) RADIOACTIVE RAY-CURABLE RESIN COMPOSITION FOR USE IN OPTICAL MEMBER AND OPTICAL MEMBER

(76) Inventors: Kang-go Chung, Tokyo (JP); Satoshi Futami, Tokyo (JP); Hiroshi Miyao, Tokyo (JP); Takayoshi Tanabe, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/917,508

(22) PCT Filed: Jun. 15, 2006
(86) PCT No.: PCT/JP2006/312454

§ 371 Date: May 28, 2008

(30) Foreign Application Priority Data
Jun. 17, 2005 (JP) 2005-178383
Dec. 13, 2005 (JP) 2005-359632

(51) Int. Cl. G02B 1/00; B32B 27/08; C08L 75/00; G02B 3/08

(52) U.S. Cl. 428/424.8; 525/123; 522/95; 359/742

(57) ABSTRACT

A radiation-curable resin composition for optical parts comprising (A) 5% to 70% by weight of a urethane (meth)acrylate which is a reaction product of (a) a (meth)acrylate having a hydroxyl group, (b) a polyisocyanate having an aromatic ring, (c) a polyol, and (d) an alcohol having 1 to 4 carbon atoms without a polymerizable unsaturated group, and which has (meth)acryloyl groups in an amount of 40% to 85% by mole of its molecular ends on average of the reaction product; and (B) 10% to 80% by weight of a compound, other than the component (A), having an ethylenically unsaturated group is provided. A cured product of the composition exhibits a high refractive index, excellent property of adhesion to various plastic substrates, appropriate hardness, and little sign of yellowing.

### TECHNICAL FIELD

The present invention relates to a radiation-curable resin composition, and more particularly relates to a radiation-curable resin composition useful for forming optical parts, for example, a lens member of a lens sheet such as a prism lens sheet used for a backlight of a liquid crystal display and a Fresnel or lenticular lens sheet used for a screen of a projection TV, and a backlight using such a sheet, and also relates to an optical part including a cured product thereof.

### BACKGROUND ART

A lens such as a Fresnel lens and a lenticular lens has been manufactured by a press method, a cast method, or the like. However, it takes a long time to manufacture a lens by these methods, which results in poor productivity.

To solve the above problem, a method of manufacturing a lens using a UV-curable resin has been attempted in recent years. Specifically, a UV-curable resin composition is poured into a space between a metal mold having a lens shape and a transparent plastic substrate, and then irradiated with UV rays from the side of the substrate to be cured, thus manufacturing the lens in a short time.

Furthermore, because projection TVs and video projectors have recently become thinner and larger, various proposals and examinations have been conducted on a resin for forming a lens according to various lens properties such as a higher refractive index and mechanical properties. For example, there has been proposed a UV-curable resin composition comprising a urethane (meth)acrylate, a monomer having an ethylenically unsaturated group, and a photopolymerization initiator (see Japanese Laid-Open Patent Publications H04-288314, H05-255464, 2001-200022).

### DISCLOSURE OF THE INVENTION

The conventional UV-curable resin composition as described above could not produce a cured product that satisfies the required lens properties such as a refractive index, the property of adhesion to various plastic substrates (especially adhesive property in heat and humidity), and releasability from a mold.

As a result of diligent study aimed at solving such problem with the conventional UV-curable resin composition, the inventors perfected the present invention upon discovering that an optical part (for example, a translucent screen such as a Fresnel lens, a lenticular lens, and the like) having a high refractive index and an excellent property of adhesion to various plastic substrates in heat and humidity can be formed in a cured product by using a radiation-curable resin composition comprising prescribed amounts of (A) a urethane (meth)acrylate partially end-capped with an alcohol such as methanol and (B) a compound, other than the component (A), having an ethylenically unsaturated group.

That is, the present invention provides the following [1] to [11].

[1] A radiation-curable resin composition for optical parts, comprising:
(A) 5% to 70% by weight of a urethane (meth)acrylate which is a reaction product of (a) a (meth)acrylate having a hydroxyl group, (b) a polyisocyanate having an aromatic ring structure, (c) a polyol, and (d) an alcohol having 1 to 4 carbon atoms without a polymerizable unsaturated group and which has (meth)acryloyl groups in an amount of 40% to 85% by mole of its molecular ends on average of the product; and
(B) 10% to 80% by weight of a compound, other than the component (A), having an ethylenically unsaturated group.
[2] The radiation-curable resin composition for optical parts according to [1], wherein the component (A) is represented by the following formula (1).

R¹—O—[CONH—R²—NHCO—O—R³—O]ₙ—CONH—R²—NHCO—O—R¹ (1)

(In the formula, R¹ is a monovalent organic group having a (meth)acryloyl group or an alkyl group having 1 to 4 carbon atoms; R² is a divalent organic group having an aromatic group; R³ is a divalent organic group having 2 to 60 carbon atoms; n is an integer of 2 to 6. R¹ has 40% to 85% by mole of (meth)acryloyl groups and 15% to 60% by mole of alkyl groups each having 1 to 4 carbon atoms on average. Two or more R¹ in a molecule are independent and may be same or different each other, and the same holds for R² and R³ respectively.)
[3] The radiation-curable resin composition for optical parts according to [1] or [2], wherein R³ in the formula (1) has a bisphenol structure.
[4] The radiation-curable resin composition for optical parts according to any one of [1] to [3], wherein R³ in the formula (1) is represented by the following formula (2).

—[CH₂—C(CH₃)H—O]ₘ-Ph-C(CH₃)₂-Ph-[O—C(CH₃)H—CH₂]ₘ— (2)

(In the formula, Ph is a p-phenylene structure; m is an integer of 1 to 3.)
[5] The radiation-curable resin composition for optical parts according to any one of [1] to [4], which comprises (C) 0.01% to 10% by weight of a photopolymerization initiator.
[6] The radiation-curable resin composition for optical parts according to any one of [1] to [5], which has a refractive index of 1.53 or more at 25° C. after cured.
[7] The radiation-curable resin composition for optical parts according to any one of [1] to [6], wherein the optical parts are optical lenses.
[8] An optical part comprising a cured product obtained by irradiating the radiation-curable resin composition according to any one of [1] to [7] with radiation.
[9] The optical part according to [8], which is an optical lens.
[10] The optical part according to [9], which is a Fresnel lens for a microdisplay projection TV.
[11] The optical part according to any one of [8] to [10], which has been manufactured by forming a cured product of the radiation-curable resin composition directly on a transparent plastic substrate made mainly of methyl methacrylate-styrene copolymer.

By using the radiation-curable resin composition for optical parts of the present invention, it is possible to form a cured product having a high refractive index, excellent property of adhesion to various plastic substrates (especially to methyl methacrylate-styrene copolymer), appropriate hardness (Young's modulus) to prevent a concavo-convex surface of a Fresnel lens and the like from being distorted, and showing little sign of yellowing.

By the cured product of the radiation-curable resin composition for optical parts of the present invention, it is possible to manufacture an optical part (for example, a Fresnel lens for a microdisplay projection TV) which has a high refractive index and an excellent property of adhesion to various plastic substrates.

### BEST MODE FOR CARRYING OUT THE INVENTION

The urethane (meth)acrylate which is the component (A) used in the radiation-curable resin composition for optical parts of the present invention (hereinafter, referred to as the composition of the present invention) is a reaction product of (a) a (meth)acrylate having a hydroxyl group, (b) a polyisocyanate having an aromatic ring structure, (c) a polyol, and (d) an alcohol having 1 to 4 carbon atoms without a polymerizable unsaturated group.

In the composition of the present invention, because the component (d) is included, not all molecular ends of the component (A) are capped with (meth)acryloyl groups.

In the urethane (meth)acrylate of the component (A), the ratio of the (meth)acryloyl groups in the molecular end groups is 40% to 85% by mole on average. When the ratio is less than 40% by mole, decreased Young's modulus of the cured product may cause distortion in the concavo-convex surface of a Fresnel lens. When the ratio exceeds 85% by mole, the property of adhesion to substrate is decreased. The ratio on average as described above means an average based on the whole reaction products of the components (a), (b), (c) and (d), and the reaction products may include a product whose both ends are capped with the component (d).

In the present description, the component (A) may be referred to as “partially alcohol end-capped urethane (meth)acrylate”, because in the component (A), the molecular ends are partly capped with alcohols (i.e. component (d)) and the rest of the molecular ends are capped with (meth) acryloyl groups. The molecular end which has been capped with an alcohol is an alkyl group having 1 to 4 carbon atoms.

The component (A) is preferably represented by the following formula (1).

R¹—O—[CONH—R²—NHCO—O—R³—O]ₙ—CONH—R²—NHCO—O—R¹ (1)

(In the formula, R¹ is a monovalent organic group having a (meth)acryloyl group or an alkyl group having 1 to 4 carbon atoms; R² is a divalent organic group having an aromatic group; R³ is a divalent organic group having 2 to 60 carbon atoms; n is an integer of 2 to 6. R¹ has 40% to 85% by mole of (meth)acryloyl groups and 15% to 60% by mole of alkyl groups each having 1 to 4 carbon atoms on average. Two or more R¹ in the molecule are independent and may be same or different each other, and the same holds for R² and R³ respectively.)

The components (a) to (d), which are materials of the component (A), will now be described below in detail.

Examples of (a) a (meth)acrylate having a hydroxyl group include 2-hydroxyethyl(meth)acrylate, 2-hydroxypropyl(meth)acrylate, 2-hydroxybutyl(meth)acrylate, 2-hydroxy-3-phenyloxypropyl (meth)acrylate, 1,4-butanediol mono(meth)acrylate, 2-hydroxyalkyl (meth)acryloyl phosphate, 4-hydroxycyclohexyl(meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, (meth)acrylates represented by the following formula (3), and the like.

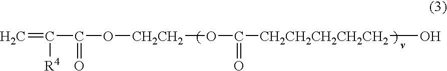

(In the formula, R⁴ is a hydrogen atom or methyl group; v is an integer of 1 to 15.) A compound obtained by addition reaction of (meth)acrylic acid and a glycidyl group-containing compound such as an alkyl glycidyl ether, allyl glycidyl ether, and glycidyl(meth)acrylate can be also used. Such a (meth)acrylate having a hydroxyl group can be used alone or in combination of two or more.

Examples of (b) an organic polyisocyanate include 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, and the like. It is preferable to use 2,4-tolylene diisocyanate, 2,6-tolylene diisocyanate, 1,3-xylylene diisocyanate, or 1,4-xylylene diisocyanate.

Examples of (c) a polyol include ethylene glycol, propylene glycol, 1,4-butanediol, neopentyl glycol, 3-methyl-1,5-pentanediol, 1,3-butanediol, cyclohexanedimethylol, tricyclodecanedimethylol, 1,6-hexanediol, 2-butyl-2-ethyl-propanediol, bisphenol A polyethoxy glycol, bisphenol A polypropoxy glycol, bisphenol A polyethoxypropoxy glycol, bisphenol F polyethoxy glycol, bisphenol F polypropoxy glycol, bisphenol F polyethoxypropoxy glycol, bisphenol S polyethoxy glycol, bisphenol S polypropoxy glycol, bisphenol S polyethoxypropoxy glycol, polytetramethylene glycol, polypropylene glycol, polybutylene glycol, polyethylenebutylene glycol, polycaprolactonediol, polyesterdiol, polycarbonatediol, and the like.

Especially, regarding the refractive index, it is preferable to use at least one type of compound selected from the group consisting of bisphenol A poly(preferably, average polymerization degree n=2˜40) ethoxy glycol, bisphenol A poly(preferably, average polymerization degree n=2˜40) propoxy glycol, bisphenol A poly(preferably, average polymerization degree n=2˜40) ethoxypropoxy glycol, bisphenol F poly(preferably, average polymerization degree n=2˜40) ethoxy glycol, bisphenol F poly(preferably, average polymerization degree n=2˜40) propoxy glycol, bisphenol F poly(preferably, average polymerization degree n=2˜40) ethoxypropoxy glycol, bisphenol S poly(preferably, average polymerization degree n=2˜40) ethoxy glycol, bisphenol S poly(preferably, average polymerization degree n=2˜40) propoxy glycol, and bisphenol S poly(preferably, average polymerization degree n=2˜40) ethoxypropoxy glycol.

The most preferred polyol is a diol which is an alkylene oxide adduct of bisphenol A represented by the following formula (4).

HO—[CH₂—C(CH₃)H—O]ₘ-Ph-C(CH₃)₂-Ph-[O—C(CH₃)H—CH₂]ₘ—OH (4)

(In the formula, Ph is a p-phenylene structure; m is an integer of 1 to 3, preferably of 1 or 2.)

Examples of commercially available products of the diol which is an alkylene oxide adduct of bisphenol A include DB400 (manufactured by Nippon Oil and Fats Co., Ltd., m=3), and so on.

The component (d), which is an alcohol having 1 to 4 carbon atoms, is added so that the ends of the obtained urethane (meth)acrylate are partially capped, not to be involved in a polymerization reaction for curing the composition of the present invention. Preferred example of the component (d), in view of improving the adhesive property, is a monohydric alcohol such as methanol, ethanol, and so on.

As the component (d), methanol is particularly preferred for improving the adhesive property. By capping a part of the ends of the urethane (meth)acrylate with an alcohol having 1 to 4 carbon atoms, the property of adhesion to various plastic substrates can be improved, though the mechanism is unknown.

Among the materials of the partially alcohol end-capped urethane (meth)acrylate, (a) a (meth)acrylate having a hydroxyl group and (d) alcohol having 1 to 4 carbon atoms, which each has a hydroxyl group able to react with an isocyanate group, are used in the reaction at the mole ratio of (a) a (meth)acrylate having a hydroxyl group and (d) alcohol having 1 to 4 carbon atoms (i.e. (a):(d)) being 85:15 to 40:60, preferably 85:15 to 70:30, particularly preferably 76:24. When the ratio is outside the above range, the property of adhesion to substrate is decreased.

Examples of the method for manufacturing the partially alcohol end-capped urethane (meth)acrylate of the component (A) include (i) a method of reacting polyol and organic polyisocyanate, and then, reacting a (meth)acrylate having a hydroxyl group and an alcohol having 1 to 4 carbon atoms, (ii) a method of reacting an organic polyisocyanate, a (meth)acrylate having a hydroxyl group, and an alcohol having 1 to 4 carbon atoms, and then, reacting a polyol, (iii) a method of reacting a polyol, an organic polyisocyanate, a (meth)acrylate having a hydroxyl group, and an alcohol having 1 to 4 carbon atoms all together.

Of these, any of the methods can be used to obtain the partially alcohol end-capped urethane (meth)acrylate used in the present invention, but the method (ii) (i.e. a method of reacting an organic polyisocyanate, a (meth)acrylate having a hydroxyl group, and an alcohol having 1 to 4 carbon atoms, and then, reacting a polyol) is preferred.

When the partially alcohol end-capped urethane (meth)acrylate, which is the component (A), is produced, (a) a (meth)acrylate having a hydroxyl group, (b) a polyisocyanate having an aromatic ring structure, (c) a polyol, and (d) an alcohol having 1 to 4 carbon atoms are used at the ratio such that isocyanate groups included in (b) a polyisocyanate having an aromatic ring are 1.1-2 equivalent, and total hydroxyl groups included in (a) a (meth)acrylate having a hydroxyl group and (d) an alcohol having 1 to 4 carbon atoms is 0.1-1 equivalent for one equivalent of hydroxyl groups included in (c) a polyol.

Preferably, the amount of isocyanate groups included in (b) an organic polyisocyanate having an aromatic ring are 1.3-2 equivalent, and the amount of total hydroxyl groups included in (a) a (meth)acrylate having a hydroxyl group and (d) an alcohol having 1 to 4 carbon atoms is 0.3-1 equivalent for one equivalent of hydroxyl groups included in (c) a polyol.

Outside the preferred range, it is difficult to handle the resin composition in liquid form. For example, the viscosity becomes higher.

When the partially alcohol end-capped urethane (meth)acrylate of the component (A) is produced, an urethanization catalyst such as copper naphthenate, cobalt naphthenate, zinc naphthenate, di-n-butyl tin dilaurate, triethylamine, and triethylenediamine-2-methyltriethyleneamine is added in an amount of from 0.01 to 1 wt % based on the total amount of the raw materials. The reaction is carried out preferably at 10-90° C., and particularly preferably at 30-80° C.

The partially alcohol end-capped urethane (meth)acrylate of component (A) has a number average molecular weight of preferably from 500 to 20,000, and more preferably from 1,000 to 15,000. If the number average molecular weight is less than 500, the adhesive property of the cured product obtained by curing the resin composition to the substrate is decreased. On the other hand, if the number average molecular weight exceeds 20,000, the viscosity is apt to increase, resulting in a difficulty in handling.

The partially alcohol end-capped urethane (meth)acrylate, which is the component (A), is used in an amount of preferably from 5 to 70 wt %, more preferably from 10 to 60 wt %, based on the total amount of the resin composition. If the amount is less than 5 wt %, it may become difficult to provide the cured product with excellent mechanical properties such as appropriate toughness. If the amount exceeds 70 wt %, workability or applicability may become poor due to the increased viscosity of the resin composition.

The component (B) used in the radiation-curable resin composition of the present invention is a compound, other than the component (A), having an ethylenically unsaturated group. Examples of the component (B) include (meth) acryloyl group-containing compounds, vinyl group-containing compounds, and the like (hereinafter referred to as ‘unsaturated monomer’).

As the unsaturated monomer, a monofunctional monomer and a polyfunctional monomer can be used.

Examples of the monofunctional monomer include vinyl monomers such as N-vinylpyrrolidone, N-vinylcaprolactam, vinylimidazole, and vinylpyridine; phenoxyethyl(meth)acrylate, phenoxy-2-methylethyl (meth)acrylate, phenoxyethoxyethyl(meth)acrylate, 3-phenoxy-2-hydroxypropyl(meth)acrylate, 2-phenylphenoxyethyl (meth)acrylate, 4-phenylphenoxyethyl(meth)acrylate, 3-(2-phenylphenyl)-2-hydroxypropyl(meth)acrylate, (meth)acrylate of ethylene oxide adduct of p-cumylphenol, 2-bromophenoxyethyl (meth)acrylate, 2,4-dibromophenoxyethyl(meth)acrylate, 2,4,6-tribromophenoxyethyl(meth)acrylate, two or more moles of ethylene oxide or propylene oxide modified phenoxy(meth)acrylate, isobornyl(meth)acrylate, bornyl(meth)acrylate, tricyclodecanyl (meth)acrylate, dicyclopentanyl(meth)acrylate, dicyclopentenyl (meth)acrylate, cyclohexyl(meth)acrylate, 4-butylcyclohexyl (meth)acrylate, acryloylmorpholine, 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl (meth)acrylate, isoamyl(meth)acrylate, hexyl(meth)acrylate, heptyl (meth)acrylate, octyl(meth)acrylate, isooctyl(meth)acrylate, 2-ethylhexyl(meth)acrylate, nonyl(meth)acrylate, decyl (meth)acrylate, isodecyl(meth)acrylate, undecyl(meth)acrylate, dodecyl(meth)acrylate, lauryl(meth)acrylate, stearyl (meth)acrylate, isostearyl(meth)acrylate, tetrahydrofurfuryl (meth)acrylate, butoxyethyl(meth)acrylate, ethoxydiethylene glycol (meth)acrylate, polyethylene glycol mono(meth)acrylate, polypropylene glycol mono(meth)acrylate, methoxyethylene glycol (meth)acrylate, ethoxyethyl(meth)acrylate, methoxypolyethylene glycol (meth)acrylate, methoxypolypropylene glycol (meth)acrylate, diacetone(meth)acrylamide, isobutoxymethyl(meth)acrylamide, N,N-dimethyl(meth)acrylamide, t-octyl(meth)acrylamide, dimethylaminoethyl(meth)acrylate, diethylaminoethyl(meth)acrylate, 7-amino-3,7-dimethyloctyl(meth)acrylate, N,N-diethyl(meth)acrylamide, N,N-dimethylaminopropyl(meth)acrylamide, hydroxybutyl vinyl ether, lauryl vinyl ether, cetyl vinyl ether, 2-ethylhexyl vinyl ether, and compounds represented by the following formula (5) or (6).

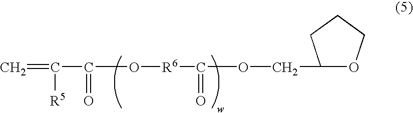

(In the formula, R⁵ is a hydrogen atom or methyl group; R⁶ is an alkylene having 2 to 8 carbon atoms; W is an integer of 1 to 8.)

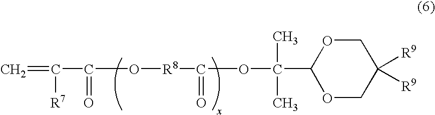

(In the formula, R⁷ and R⁹ are each independently a hydrogen atom or methyl group; R⁸ is an alkylene having 2 to 8 carbon atoms; X is an integer of 1 to 8.)

Of these, phenoxyethyl(meth)acrylate, and the like are preferred.

Examples of the polyfunctional monomer include trimethylolpropane tri(meth)acrylate, pentaerythritol tri(meth)acrylate, pentaerythritol tetra(meth)acrylate, ethylene glycol di(meth)acrylate, tetraethylene glycol di(meth)acrylate, polyethylene glycol di(meth)acrylate, polypropylene glycol di(meth)acrylate, 1,4-butanediol di(meth)acrylate, 1,6-hexanediol di(meth)acrylate, neopentyl glycol di(meth)acrylate, trimethylolpropanetrioxyethyl(meth)acrylate, tris(2-hydroxyethyl)isocyanurate tri(meth)acrylate, tris(acryloyloxy)isocyanurate, bis(hydroxymethyl)tricyclodecane di(meth)acrylate, dipentaerythritol hexa(meth)acrylate, di(meth)acrylate of a diol which is an ethylene oxide adduct or a propylene oxide adduct of bisphenol A, di(meth)acrylate of a diol which is an ethylene oxide adduct or a propylene oxide adduct of hydrogenated bisphenol A, epoxy(meth)acrylate which is a (meth)acrylate adduct of a diglycidyl ether of bisphenol A, triethylene glycol divinyl ether, and the like. Of these, dipentaerythritol hexa(meth)acrylate, tripropylene glycol di(meth)acrylate, pentaerythritol tetra(meth)acrylate, and di(meth)acrylate of a diol which is an ethylene oxide adduct or a propylene oxide adduct of bisphenol A are preferred.

Examples of commercially available products used as the monofunctional monomer include ARONIX M101, M102, M110, M111, M113, M117, M5700, TO-1317, M120, M150, M156 (manufactured by TOAGOSEI CO., LTD.); LA, IBXA, 2-MTA, HPA, Viscoat #150, #155, #158, #190, #192, #193, #220, #2000, #2100, #2150 (manufactured by OSAKA ORGANIC CHEMICAL INDUSTRY LTD.); LIGHT-ACRYLATE BO-A, EC-A, DMP-A, THF-A, HOP-A, HOA-MPE, HOA-MPL, PO-A, P-200A, NP-4EA, NP-8EA, epoxyester M-600A (manufactured by KYOEISYA CHEMICAL Co., LTD.); KAYARAD TC110S, R-564, R-128H (manufactured by NIPPON KAYAKU CO., LTD.); NK ESTER AMP-10G, AMP-20G (manufactured by SHIN-NAKAMURA CHEMICAL CO., LTD.); FA-511A, 512A, 513A (manufactured by Hitachi Chemical Co., Ltd.); PHE, CEA, PHE-2, PHE-4, BR-31, BR-31M, BR-32 (manufactured by DAI-ICHI KOGYO SEIYAKU CO., LTD.); VP (manufactured by BASF Corporation); ACMO, DMAA, DMAPAA (manufactured by KOHJIN Co., Ltd.); and the like.

Examples of commercially available products used as the polyfunctional monomer include Yupimer UV SA1002, SA2007 (manufactured by Mitsubishi Chemical Corporation); Viscoat #195, #230, #215, #260, #335HP, #295, #300, #360, #700, GPT, 3PA (manufactured by OSAKA ORGANIC CHEMICAL INDUSTRY LTD.); LIGHT-ACRYLATE 4EG-A, 9EG-A, NP-A, DCP-A, BP-4EA, BP-4PA, TMP-A, PE-3A, PE-4A, DPE-6A (manufactured by KYOEISYA CHEMICAL Co., LTD); KAYARAD PET-30, TMPTA, R-604, DPHA, DPCA-20, -30, -60, -120, HX-620, D-310, D-330 (manufactured by NIPPON KAYAKU CO., LTD.); ARONIX M208, M210, M215, M220, M240, M305, M309, M310, M315, M325, M400 (manufactured by TOAGOSEI CO., LTD.); Ripoxy VR-77, VR-60, VR-90 (manufactured by SHOWA HIGHPOLYMER CO., LTD.); and the like.

The component (B) is used in an amount of preferably from 10 to 80 wt %, more preferably from 20 to 80 wt %, based on the total amount of the resin composition. If the amount is less than 10 wt %, the resin composition may become inferior in viscosity or the cured product thereof may become inferior in refractive index. If the amount exceeds 80 wt %, it may be difficult to keep sufficient mechanical properties, or poor applicability may arise.

The radiation-curable resin composition of the present invention is cured by radiation. Radiation used herein includes ionizing radiation such as infrared rays, visible rays, ultraviolet rays, X-rays, electron beams, α-rays, β-rays, γ-rays. Generally, ultraviolet rays and the like are used for its convenience. For photo-curing reaction, component (C), which is a photopolymerization initiator, is added as required, and further, a photosensitizer is optionally added.

As the photopolymerization initiator, any compound that decomposes upon irradiation and generates radicals to initiate a polymerization can be used. Examples of the photopolymerization initiator include acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyl diphenylphosphine oxide, and bis-(2,6-dimethoxybenzoyl)-2,4,4-trimethylpentylphosphine oxide, and the like.

Examples of commercially available products used as (C) a photopolymerization initiator include Irgacure 184, 369, 651, 500, 819, 907, 784, 2959, CGI-1700, -1750, -1850, CG24-61, Darocur 1116, 1173 (manufactured by Ciba Specialty Chemicals); Lucirin TPO, LR8893, LR8970 (manufactured by BASF Corporation); Ubecryl P36 (manufactured by UCB); and the like.

Examples of the photosensitizer include triethylamine, diethylamine, N-methyldiethanoleamine, ethanolamine, 4-dimethylaminobenzoic acid, methyl 4-dimethylaminobenzoate, ethyl 4-dimethylaminobenzoate, and isoamyl 4-dimethylaminobenzoate. As commercially available products of the photosensitizer, Ubecryl P102, 103, 104, and 105 (manufactured by UCB) can be given.

The optimum amount of the photopolymerization initiator used to cure the resin composition of the present invention is from 0.01 to 10 wt %, and preferably from 0.5 to 7 wt % of the total amount of the resin composition. If the amount is less than 0.01 wt %, the curing speed may be decreased, resulting in a decrease in reaction efficiency. If the amount exceeds 10 wt %, curing characteristics and handling of the composition may become poor, or mechanical properties and optical characteristics of the cured product may become poor.

A heat-polymerization initiator can be optionally added when the resin composition of the present invention is cured. Peroxides and azo compounds are preferable heat-polymerization initiators. Specific examples include benzoyl peroxide, t-butyl peroxybenzoate and azobisisobutyronitrile.

Curable oligomers or polymers other than the above components may be optionally added to the resin composition of the present invention insofar as the characteristics of the resin composition are not adversely affected.

Examples of such curable oligomers or polymers include polyurethane (meth)acrylate other than the component (A), polyester (meth)acrylate, epoxy(meth)acrylate, polyamide(meth)acrylate, siloxane polymers having a (meth)acryloyloxy group, and reactive polymers produced by reacting a copolymer of glycidyl(meth)acrylate and other polymerizable monomers with (meth)acrylic acid.

In addition to the above components, additives such as antioxidants, UV absorbers, light stabilizers, silane coupling agents, coating surface improvers, heat-polymerization inhibitors, leveling agents, surfactants, coloring agents, preservatives, plasticizers, lubricants, mold release agent, solvents, fillers, aging preventives, wettability improvers, can be added as required.

Examples of antioxidants include Irganox 1010, 1035, 1076, 1222 (manufactured by Ciba Specialty Chemicals); Antigene P, 3C, FR, Sumilizer GA-80 (manufactured by Sumitomo Chemical Co., Ltd).

Examples of UV absorbers include Tinuvin P, 234, 320, 326, 327, 328, 329, 213 (manufactured by Ciba Specialty Chemicals); Seesorb 102, 103, 110, 501, 202, 712, 704 (manufactured by SHIPRO KASEI KAISHA, LTD.).

Examples of light stabilizers include Tinuvin 292, 144, 622LD (manufactured by Ciba Specialty Chemicals); SANOL LS770 (manufactured by Sankyo Co., Ltd.); Sumisorb TM-061 (manufactured by Sumitomo Chemical Co., Ltd).

Examples of silane coupling agents include γ-aminopropyltriethoxysilane, γ-mercaptopropyltrimethoxysilane, and γ-methacryloxypropyltrimethoxysilane. Commercially available products thereof include SH6062, SH6030 (manufactured by Dow Corning Toray Silicone Co., Ltd.), and KBE903, 603, 403 (manufactured by Shin-Etsu Chemical Co., Ltd.).

Examples of coating surface improvers include silicone additives such as dimethylsiloxane polyether. Commercially available products thereof include DC-57, DC-190 (manufactured by Dow Corning Corporation), SH-28PA, SH-29PA, SH-30PA, SH-190 (manufactured by Dow Corning Toray Silicone Co., Ltd.), KF351, KF352, KF353, KF354 (manufactured by Shin-Etsu Chemical Co., Ltd.), and L-700, L-7002, L-7500, FK-024-90 (manufactured by Nippon Unicar Company Limited).

The resin composition of the present invention is manufactured by mixing the above components using a conventional method. Viscosity of the resin composition of the present invention thus prepared is usually from 200 to 50,000 mPa·s/25° C., and preferably from 500 to 30,000 mPa·s/25° C. If the viscosity is too high, uneven coating or crinkling occurs in the production of lens, or it is difficult to obtain a desired lens thickness, thereby resulting in inadequate lens performance. On the other hand, if the viscosity is too low, it is difficult to control the thickness of a lens and to manufacture lenses with a uniform thickness.

The refractive index of the cured product of the resin composition of the present invention at 25° C. is preferably 1.53 or more, and more preferably 1.54 or more. If the refractive index is less than 1.53, a translucent screen formed by using the resin composition may exhibit insufficient frontal brightness.

The Young's modulus (40° C.) of the cured product of the resin composition of the present invention is preferably 200 MPa or more, more preferably 300 MPa or more, still more preferably 400 MPa or more, and particularly preferably 500 MPa or more. When the Young's modulus is within the above range, the cured product has adequate hardness, and thereby the concavo-convex surface structure of the Fresnel lens is hard to be distorted.

The upper limit of the Young's modulus of the cured product of the resin composition of the present invention is usually, but is not limited to, 2,000 MPa and below.

The cured product obtained by irradiating the resin composition of the present invention with ultraviolet rays is useful for optical parts such as a lens member of a prism lens sheet, Fresnel lens sheet, or lenticular lens sheet, and a backlight using such a sheet, and is particularly useful for optical lenses.

Among such optical lenses, an optical lens, which is obtained by the UV-curable resin composition being poured into a space between a mold having a lens shape and a transparent plastic substrate, and irradiated with ultraviolet rays from the side of the substrate to be cured, is particularly preferred.

Thus, the preferred optical lens of the present invention is a lens obtained by forming the cured product (i.e. lens body) of the resin composition of the present invention directly on the transparent plastic substrate.

As the transparent plastic substrate, a substrate made mainly of polymethyl methacrylate (PMMA) or methyl methacrylate-styrene copolymer (MS). Of these, the substrate made mainly of methyl methacrylate-styrene copolymer (MS) is particularly preferred.

### EXAMPLES

The present invention will now be explained in more detail by Examples. The following Examples are not intended to limit the scope of the present invention.

### Synthesis Example 1

### Synthesis of Urethane (Meth)Acrylate

A reaction vessel equipped with a stirrer was charged with 32.52 wt % of 2,4-tolylene diisocyanate, 0.08 wt % of di-n-butyltin dilaurate, and 0.02 wt % of 2,6-di-t-butyl-p-cresol. 10.84 wt % of 2-hydroxyethyl acrylate was added drop wise while stirring so as to maintain the temperature at 30° C. or lower. After the addition, the mixture was reacted for one hour at 30° C. 56.64 wt % of bisphenol A polypropoxy glycol (DB400 manufactured by Nippon Oil and Fats Co, Ltd.) was then added and the mixture was reacted at 50-70° C. for two hours. The reaction was terminated when the amount of the residual isocyanate was 0.1 wt % or less. The resulting urethane acrylate is referred to as “oligomer A-1”.

In the oligomer A-1, the ratio of acryloyl groups in the molecular end groups is 100 mol %. Therefore, the oligomer A-1 doesn't correspond to the component (A) of the present invention.

### Synthesis Example 2

### Synthesis of Methanol 24% End-Capped Urethane (Meth)Acrylate

A urethane (meth)acrylate in which 24% of molecular ends are capped with methanol was obtained by the same process as Synthesis Example 1, excepting that 0.73 wt % of methanol was added with 2,4-tolylene diisocyanate and the added amounts of 2,4-tolylene diisocyanate, 2-hydroxyethyl acrylate, and bisphenol A polypropoxy glycol were changed to 33.15 wt %, 8.40 wt %, and 57.72 wt % respectively.

The obtained urethane acrylate partially end-capped with methanol is referred to as “oligomer A-2”.

The mole ratio of methanol based on the total amount of 2-hydroxyethyl acrylate and methanol is 24%.

In the oligomer A-2, the ratio of acryloyl group based on molecular end groups is 76 mol % on average of the whole of the oligomer. Therefore, the oligomer A-2 corresponds to the component (A) of the present invention.

### Synthesis Example 3

### Synthesis of Methanol 12% End-Capped Urethane (Meth)Acrylate

A urethane (meth)acrylate in which 12% of molecular ends are capped with methanol was obtained by the same process as Synthesis Example 1, excepting that 0.36 wt % of methanol was added with 2,4-tolylene diisocyanate and the added amounts of 2,4-tolylene diisocyanate, 2-hydroxyethyl acrylate, and bisphenol A poly(average polymerization degree m=3) propoxy glycol were changed to 32.83 wt %, 9.63 wt %, and 57.14 wt % respectively.

The obtained urethane acrylate partially end-capped with methanol is referred to as “oligomer A-3”.

The mole ratio of methanol based on the total amount of 2-hydroxyethyl acrylate and methanol is 12%.

In the oligomer A-3, the ratio of acryloyl group based on molecular end groups is 88 mol % on average of the whole of the oligomer. Therefore, the oligomer A-3 doesn't correspond to the component (A) of the present invention.

### Example 1

A reaction vessel equipped with a stirrer was charged with 36 wt % of “A-2” as component (A), 10 wt % of dipentaerythritol hexaacrylate, 14 wt % of tripropylene glycol diacrylate, 10 wt % of acrylate of ethylene oxide adduct of bisphenol A, and 30 wt % of phenoxyethyl acrylate as component (B), 3 wt % of 1-hydroxycyclohexyl phenyl ketone as component (C), and other components shown in Table 1. The mixture was stirred for one hour while maintaining the liquid temperature at 50-60° C. to obtain a homogeneous liquid curable resin composition.

As for Examples 2-4 and Comparative Examples 1-2, liquid resin compositions were obtained by charging the reaction vessel with the components shown in Table 1. The unit of the added amounts of the components employed in Table 1 is weight parts.

### [Evaluation Methods]

Test specimens were prepared using the obtained liquid curable resin compositions in Examples 1-4 and Comparative Examples 1-2 according to the method described below. The property of adhesion to substrate, Young's modulus, and ΔYI (Yellow Index change over time) were measured according to the following methods.

### [Property of Adhesion to Substrate]

The liquid curable resin composition was applied to a metal mold having a Fresnel lens shape (hereinafter abbreviated to as lens mold), and the mold was covered with 1.8 millimeter-thick methyl methacrylate-styrene (MS) copolymer substrate (10 cm×10 cm) from the side of the resin composition while no bubble entered into the composition. The MS substrate was then pressurized so that the thickness of the resin composition became constant (100 μm).

The resin composition layer was cured by irradiating with ultraviolet rays at a dose of 1.0 J/cm² from the side of the substrate. A lens substrate consisting of the cured product (i.e. lens) of the liquid curable resin composition and the MS substrate was removed from the mold by hand. The adhesion of the lens substrate peeled off from the mold was evaluated by the method of tearing off the lens from the MS substrate using a cutter and also by the method of measuring adhesive property to the MS substrate from the peeled side by a cross-cut peeling test according to JIS K5400.

The case that the lens was not torn off by the tearing method by cutter, and all of the cross-cut pieces fully adhered to the MS substrate with no pieces separating from the substrate on the cross-cut test was taken as “⊚”. The case that the lens was partially torn off by the tearing method by cutter, and all of the cross-cut pieces fully adhered to the MS substrate with no pieces separating from the substrate was taken as “◯”. The case that the cross-cut pieces partially separated from the MS substrate was taken as “Δ”. The case that all of the cross-cut pieces separated from the MS substrate was taken as “X” on the cross-cut test.

### [Young's Modulus]

The Young's modulus of the cured product of the liquid curable resin composition was measured as below.

The liquid curable resin composition was applied onto a glass plate using 381 micrometer-thick applicator bar, and then, irradiated with ultraviolet rays at a dose of 1 J/cm² to be cured, thus forming a cured film. The cured film was cut into a strip-shaped test sample which includes a portion having a width of 6 mm and a length of 25 mm to be drawn in the tensile test described below.

Tensile test was carried out for the strip-shaped sample at a temperature of 40° C. and a humidity of 50% using tensile testing machine according to JIS K7127. The Young's modulus (MPa) was calculated on the value of stress at a distortion of 2.5% and a drawing rate of 1 mm/min.

### [Yellow Index]

ΔYI (i.e. degree of change in Yellow Index over time; Yellow Index shows a degree of yellowing.) of the cured product of the liquid curable resin composition was measured as below.

The liquid curable resin composition was applied onto a glass slide using 253 micrometer-thick applicator bar, and then, irradiated with ultraviolet rays at a dose of 1.0 J/cm² using a metal halide lamp, thus forming a cured film having a thickness of 130 μm.

The cured film on the glass slide was left at a temperature of 100° C. for 7 days.

The degree of change of the hue of the cured film was evaluated by YI (Yellow Index) using a calorimeter (SZ-Σ80 spectral calorimeter manufactured by Nippon Denshoku Industries Co., Ltd.). ΔYI indicates the difference between YI value after being left for 7 days after manufacturing and YI value immediately after manufacturing. Fewer ΔYI indicates less increase in yellowing over time, that is, less change in hue over time.

TABLE 1

| | | | | | | Comparative | Comparative |
|---|---|---|---|---|---|---|---|
| Composition (weight part) | | Example 1 | Example 2 | Example 3 | Example 4 | Example 1 | Example 2 |
| Oligomer | A-1 (not end-capped with methanol) | — | — | — | — | 36 | — |
| | A-2 (24% end-capped with methanol) | 36 | 29 | 29 | 27 | — | — |
| | A-3 (12% end-capped with methanol) | — | — | — | — | — | 36 |
| Monomer | B-1 dipentaerythritol hexaacrylate | 10 | 12.5 | 23.5 | 27 | 10 | 10 |
| | B-2 tripropylene glycol diacrylate | 14 | 13 | 4.5 | 4 | 14 | 14 |
| | B-3 pentaerythritol triacrylate | — | — | 4 | 3 | — | — |
| | B-4 acrylate of ethyleneoxide adduct | 10 | 8 | — | — | 10 | 10 |
| | of bisphenol A | | | | | | |
| | B-5 phenoxyethyl acrylate | 30 | 37 | 39 | 39 | 30 | 30 |
| The sum of oligomer and monomer | | 100 | 99.5 | 100 | 100 | 100 | 100 |
| Additive | Irganox 1035 | 0.3 | 0.3 | 0.3 | 0.3 | 0.3 | 0.3 |
| | Tinuvin 292 | 0.15 | 0.15 | 0.15 | 0.15 | — | — |
| | SH28PA(DC-190) | 0.5 | 0.2 | 0.02 | 0.02 | 0.5 | 0.5 |
| | SH190(DC-57) | 0.5 | 0.2 | 0.02 | 0.02 | 0.5 | 0.5 |
| | ADDID700 | 0.002 | 0.002 | 0.002 | 0.002 | 0.002 | 0.002 |
| Photopolymerization | 1-hydroxycyclohexyl phenyl ketone | 3 | 3 | 3 | 3 | 3 | 3 |
| initiator | | | | | | | |
| Evaluation | Adhesion to substrate | ⊚ | ⊚ | ⊚ | ⊚ | Δ | Δ |
| | Young's modulus (MPa) | 270 | 310 | 600 | 700 | 290 | 280 |
| | ΔYI | 0.3 | 0.3 | 0.3 | 0.3 | 1 | 1.1 |

The components shown in Table 1 are as follows.
[B-1] dipentaerythritol hexaacrylate; manufactured by NIPPON KAYAKU CO., LTD.; trade name: KAYARAD DPHA
[B-2] tripropylene glycol diacrylate; manufactured by NIPPON KAYAKU CO., LTD.; trade name: KS-TPGDA
[B-3] pentaerythritol triacrylate; manufactured by SHIN-NAKAMURA CHEMICAL CO., LTD.; trade name: A-TMN-3LM-N
[B-4] acrylate of ethyleneoxide adduct of bisphenol A; manufactured by OSAKA ORGANIC CHEMICAL INDUSTRY LTD.; trade name: Viscoat #700
[B-5] phenoxyethyl acrylate; manufactured by DAI-ICHI KOGYO SEIYAKU CO., LTD.; trade name: New Frontier PHE
[Additives]
Irganox 1035: manufactured by Ciba Specialty Chemicals; 2,2′-thiodiethyl-bis-[3,5-di-t-butyl-4-hydroxyphenyl)propionate]
Tinuvin 292: manufactured by Ciba Specialty Chemicals; 1-methyl-8-(1,2,2,6,6-pentamethyl-4-piperidinyl)-sebacate
SH28PA(DC-190): manufactured by Dow Corning Toray Silicone Co., Ltd.; dimethylpolysiloxanepolyoxyalkylene copolymer
SH190(DC-57): manufactured by Dow Corning Toray Silicone Co., Ltd.; dimethylpolysiloxanepolyoxyalkylene copolymer
ADDID700: manufactured by Wacker Chemicals East Asia Ltd.; silicone adulterant

Table 1 shows that the cured products of the radiation-curable resin compositions of Examples 1-4 using the methanol 24% end-capped urethane (meth)acrylate excel in the property of adhesion to substrate, Young's modulus, and ΔYI (less change in hue over time). On the contrary, Table 1 shows that Comparative Examples 1 and 2, in which the urethane (meth)acrylate not end-capped with methanol and the urethane (meth)acrylate 12% end-capped with methanol are used respectively, are inferior in the property of adhesion to substrate and ΔYI.

1. A radiation-curable resin composition for optical parts, comprising:
(A) 5% to 70% by weight of a urethane (meth)acrylate which is a reaction product of (a) a (meth)acrylate having a hydroxyl group, (b) a polyisocyanate having an aromatic ring structure, (c) a polyol, and (d) an alcohol having 1 to 4 carbon atoms without a polymerizable unsaturated group, and which has (meth)acryloyl groups in an amount of 40% to 85% by mole of its molecular ends on average of the reaction product; and
(B) 10% to 80% by weight of a compound, other than the component (A), having an ethylenically unsaturated group.

2. The radiation-curable resin composition for optical parts according to claim 1, wherein the component (A) is represented by the following formula (1).
R¹—O—[CONH—R²—NHCO—O—R³—O]ₙ—CONH—R²—NHCO—O—R¹ (1)
(In the formula, R¹ is a monovalent organic group having a (meth)acryloyl group or an alkyl group having 1 to 4 carbon atoms; R² is a divalent organic group having an aromatic group; R³ is a divalent organic group having 2 to 60 carbon atoms; n is an integer of 2 to 6. R¹ has 40% to 85% by mole of (meth)acryloyl groups and 15% to 60% by mole of alkyl groups each having 1 to 4 carbon atoms on average. Two or more R¹ in a molecule are independent and may be same or different each other, and the same holds for R² and R³ respectively.)

3. The radiation-curable resin composition for optical parts according to claim 2, wherein R³ in the formula (1) has a bisphenol structure.

4. The radiation-curable resin composition for optical parts according to claim 2, wherein R³ in the formula (1) is represented by the following formula (2).
—[CH₂—C(CH₃)H—O]ₘ-Ph-C(CH₃)₂-Ph-[O—C(CH₃)H—CH₂]ₘ— (2)
(In the formula, Ph is a p-phenylene structure; m is an integer of 1 to 3.)

5. The radiation-curable resin composition for optical parts according to claim 1, which comprises (C) 0.01% to 10% by weight of a photopolymerization initiator.

6. The radiation-curable resin composition for optical parts according to claim 1, which has a refractive index of 1.53 or more at 25° C. after cured.

7. The radiation-curable resin composition for optical parts according to claim 1, wherein the optical parts are optical lenses.

8. An optical part comprising a cured product obtained by irradiating the radiation-curable resin composition according to claim 1 with radiation.

9. The optical part according to claim 8, which is an optical lens.

10. The optical part according to claim 9, which is a Fresnel lens for a microdisplay projection TV.

11. The optical part according to any one of claims 8 to 10, which has been manufactured by forming a cured product of the radiation-curable resin composition directly on a transparent plastic substrate made mainly of methyl methacrylate-styrene copolymer.
